(19) United States
(12) Patent Application Publication
(10) Pub. No.: US 2015/0277219 A1
(43) Pub. Date: Oct. 1, 2015

(54) PROCESSOR-BASED DEVICE WITH EMISSIVE DISPLAY AND REMOVABLE SCREEN

(71) Applicants: Paul J. Gwin, Orangevale, CA (US); Mark E. Sprenger, Folsom, CA (US)

(72) Inventors: Paul J. Gwin, Orangevale, CA (US); Mark E. Sprenger, Folsom, CA (US)

(21) Appl. No.: 14/227,023

(22) Filed: Mar. 27, 2014

(51) Int. Cl. G03B 21/58; G03B 21/62

(52) U.S. Cl. CPC G03B 21/58; G03B 21/62

(57) ABSTRACT

In accordance with some embodiments, a processor-based device may be implemented with an emissive projection display that is removable from the device. The screen only may be removable in some embodiments and, in other embodiments, the screen, together with the emissive projection display, may be removable from the processor-based device.

### BACKGROUND

This relates generally to displays for processor-based devices, such as computers, cell phones and game devices.

Emissive projection displays use stacked film layers with fluorescent particles so that different colors can be produced. For example, an emissive projection display with films placed on the windshield of a vehicle may be used to make a heads up display. A sandwich of blue fluorescent film, green fluorescent film, red fluorescent film, and ultraviolet absorption film may, when exposed to light in each waveband, cause the corresponding film to generate color emissions in the red, green and blue visible wavelengths. Absorption film is not required. The film absorbs the wavelength of invisible (UV) light that it is tuned for and, in turn, emits a wavelength of light corresponding to the color that it is tuned for, either red, green or blue in a 360 degree sphere.

### BRIEF DESCRIPTION OF THE DRAWINGS

Some embodiments are described with respect to the following figures:

FIG. 1 is a cross-sectional view of one embodiment with the screen in place on a processor-based device;

FIG. 2 is a side elevational view of the embodiment shown in FIG. 1 after the screen has been removed from the processor-based device, according to one embodiment;

FIG. 3 is a cross-sectional view of another embodiment;

FIG. 4 is a side elevational view of the embodiment of FIG. 3 after the screen has been removed;

FIG. 5 is a top plan view of the device with screen in place; and

FIG. 6 is a top plan view with the screen raised over the rest of the processor-based device, according to one embodiment.

### DETAILED DESCRIPTION

In accordance with some embodiments, a processor-based device may be implemented with an emissive projection display that is removable from the device. The screen only may be removable in some embodiments and, in other embodiments, the screen, together with the emissive projection display, may be removable from the processor-based device.

Embodiments may be implemented in connection with cellular telephones, laptop computers, tablet computers, electronic or e books, and game devices, to mention some examples.

Generally, the emissive projection display uses a light emitting material incorporated into a substantially transparent substrate. The substrate may for example be glass, plastic, polymer or other substantially transparent material. The excitation light may be, for example, ultraviolet light or infrared light from a projector or laser. Generally the projected light is absorbed by the light emitting material in the substrate.

The light emitting material emits visible light on both sides of the screen, in 360 degrees, that receives the excitation light. One can use a light absorbing background to enhance the contrast of the display. As a result, images may be produced by selectively illuminating the substrate with excitation light. For example, in an embodiment in which the projected light is ultraviolet, the particles within the substrate emit light when exposed to ultraviolet light that has a shorter wavelength and higher energy than visible light. So when the light emitting material in the screen absorbs ultraviolet light and emits lower energy visible light, the ultraviolet light is down converted to visible light because the ultraviolet light's energy level is reduced.

In other embodiments, the projected light may be infrared light. Since the infrared light has a longer wavelength and lower energy than visible light, when the light emitting material absorbs the infrared light, it is up converted to visible light because the infrared light's energy level goes up when it is converted into visible light.

The projector may be any digital projector including a micro mirror array such as a digital light processing projector. In other embodiments the projector may be a liquid crystal display projector. Other projectors may also be used including a pico projector.

In some embodiments, the light emitting particles may be integrated into the substrate and in other embodiments they may be coated on the substrate. Generally the light emitting material may be fluorescent material that emits visible light upon exposure to electromagnetic radiation such as visible light, ultraviolet light or infrared light that is of a different wavelength than the emitted visible light. Generally the size of the particles may be smaller than the wavelength of the visible light which reduces or eliminates visible light scattering by the particles. For example the particles may be nanoparticles or molecules having a diameter that is less than 400 nanometers in one embodiment. Generally different particles are used to produce different colors of light.

In down conversion embodiments, the light emitting particles that emit red may include Europium, light emitting particles that emit green light include Terbium and the light emitting particles that emit blue or yellow light may be Cerium and/or Thulium. In up conversion embodiments, the light emitting particles which emit red light may include Praseodymium, light emitting particles that emit green light may include Erbium and light emitting particles that emit blue light may include Thulium. An embodiment in which light emitting particles are fluorescent molecules that emit different colors they include pure organic or organo-metallic dyes.

The glass for the fluorescent screen may include inorganic solids that are transparent or translucent to visible light. Examples of such inorganic solids include oxides and halides. The glass may include silicates, borosilicate, leaded crystal, aluminum, silica, fused silica, quartz, glass ceramics, metal fluorides and other similar materials. Plastics for fluorescent and screens may include organic and polymeric solids that are transparent or translucent to visible light. Thermoplastic for fluorescent screens may include special thermal set solids such as transparent gels. Some examples of plastics include polyacrylic, polycarbonate, polyethylene, polypropylene, polystyrene, polyvinyl chloride, silicon and other materials.

The glass or plastic screens may have fluorescent dyes. Fluorescent dyes are organic molecules or material that absorb a high energy photon and emit a lower energy photon. To emit visible light, these molecules absorb ultraviolet light or lower wavelength visible light in the wavelength range of 190-590 nanometers or in the wavelength range of 300-450 nanometers. Examples of fluorescent dyes may include commercial dye molecules available from vendors including Lambda Physik and Exciton. Fluorescent dyes that may be used in a transparent display include Pyrromethene, Courmarin, Rhodamine, Fluorescein and other aromatic hydrocarbons and their derivatives. In addition, polymers containing unsaturated bonds can be fluorescent materials that may be used in a transparent display including poly[2-methoxy-5-(2′-ethylhexyloxy)-p-phenylene vinylene] (MEH-PPV) that have been used in optoelectronic devices such as polymer emitting diodes. Glass or plastics may be made fluorescent by combining them with phosphor materials. The down conversion phosphors including inorganic and ceramic particles or nanoparticles including but not limited to metal oxides, metal halides, metal chalcogenides or their hybrids such as metal oxo-halides and metal oxo-chalcogenides. These inorganic phosphors are used in fluorescent lights and electronic monitors and have been applied in converting shorter wavelength light and to higher wavelength light. It may be dispersed or coated on the screen and excited by corresponding shorter wavelength projected light.

Fluorescent phosphors or dye molecules can be excited into the visible light range by projecting light ranging from ultraviolet to blue light. Light sources for these projectors may emit light in the range of the wavelengths. These light sources include halogen lamps, incandescent lamps and arc vapor lamps.

Phosphors containing metal oxide hosts, metal oxohalides, oxo-sulfides, metal halides, metal sulfides and chalcogenides may be applied to the projected fluorescent displays. As an example, the Garnet series of phosphors (Yₘ, A₁₋ₘ)₃Alₙ, B₁₋ₙ), ₅O₁₂ doped with Cerium where 0≦m, n≦1; A includes other rare earth elements, B includes boron and/or galium. In addition, phosphors containing common rare earth elements in transitional or main group elements as a fluorescent activators may be applied to the projection displays. Some undoped material such as metal, calcium, zinc, cadmium and zinc oxide are also luminescent materials and may be used. Organic dyes and inorganic phosphors may be filled in or coated on glass or plastic substrates. The dye molecules will not scatter the visible light if dissolved on the coated glass or plastic material. Larger phosphor particles scatter visible light which affects the optical transparency of the substrate. In some embodiments, phosphor particles may be reduced in size. In some embodiments, the concentration of the phosphor particles is reduced and evenly dispersed on the substrate. In some embodiments the substrate is chosen with a refractive index close to that of the phosphors to reduce the scattering or the phosphors are chosen with refractive indices close to those of the substrate.

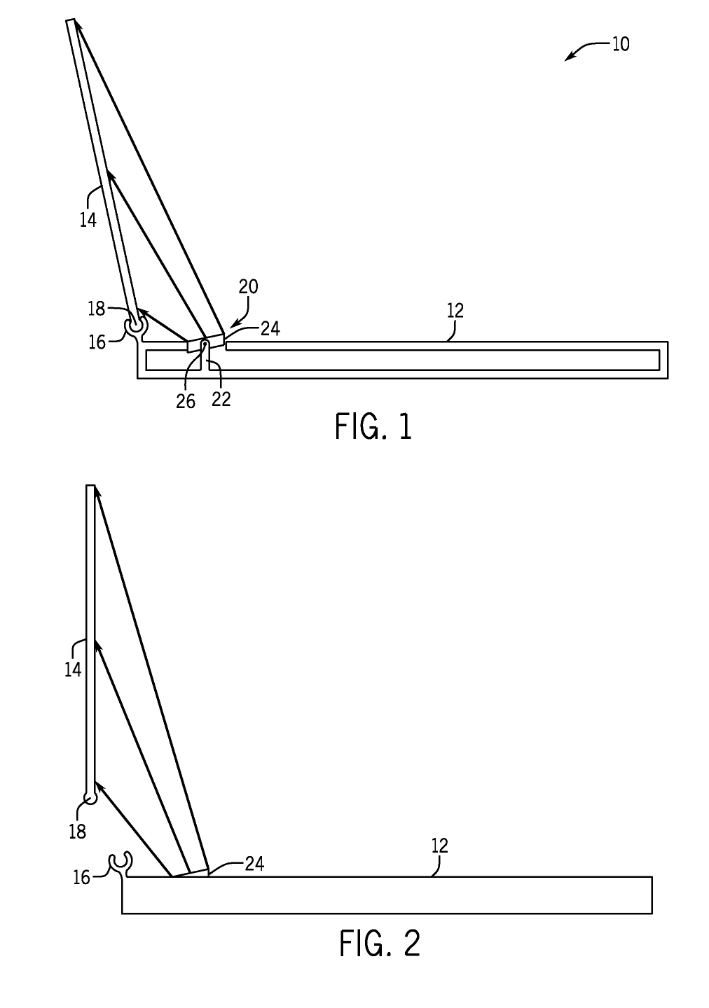

Referring to FIG. 1, an example of a laptop-type computer may have a body or base 12, which may include electronic components including a processor (not shown). The base 12 may be removably connected to a transparent display screen 14. The screen may be replaced on the housing by reconnecting it in the same manner it was connected before removal. The screen 14 may have a sandwich of layers coated thereon, such that when light is projected to the screen, they fluoresce in appropriate wavelengths to produce blue, green and red images.

The projector 20 may include an emitter 24 that may be mounted on a stalk 22 that may be integrally molded in the base 12, in one embodiment. The screen may be mounted on the stalk via an axle 26 so that the emitter 24 may be pivoted about the base 12 on that axle. As a result, the emitter may cause light to be emitted in the general direction of the current screen position. As shown, the screen may be rotated and the emitter 24 may be rotated in order to project an image on the screen in various positions.

The screen may have a removable connection to the base 12 via by enlarged end 18 that snap fits into a spring slot 16 as shown in FIG. 2. In one embodiment, the spring slot 16 is formed by the natural resiliency of the plastic material used to form the base 12. The enlarged end then is simply pushed into the groove in the base and is removably held therein for rotation relative to the base.

Other types of removable and replaceable attachments may also be used, including magnetic connections and latched connections.

Thus, as the screen 14 is rotated, the emitter 24 may be rotated to enable a display to be centered on the display screen. The projector output is screwed asymmetrically such that the light pattern accounts for the light path to the display to place light in the correct location (i.e. the light is not normal to the display).

Then, if preferred, the display screen may simply be removed from its connection to the base 12 by forcefully disengaging the screen. Then the display screen can be placed in any other location within the projector's range. For example, when transitioning from displaying for one user to a group of users, for example for a presentation, it may be desirable to position the display so that it can be viewed by the presentation participants. Thus, the screen may be detached and held or mounted in any desired location. The light source is reoriented accordingly.

Generally, with emissive projection displays, the display material itself is transparent so that it is viewed from both sides equally as long as the light is not interfered with.

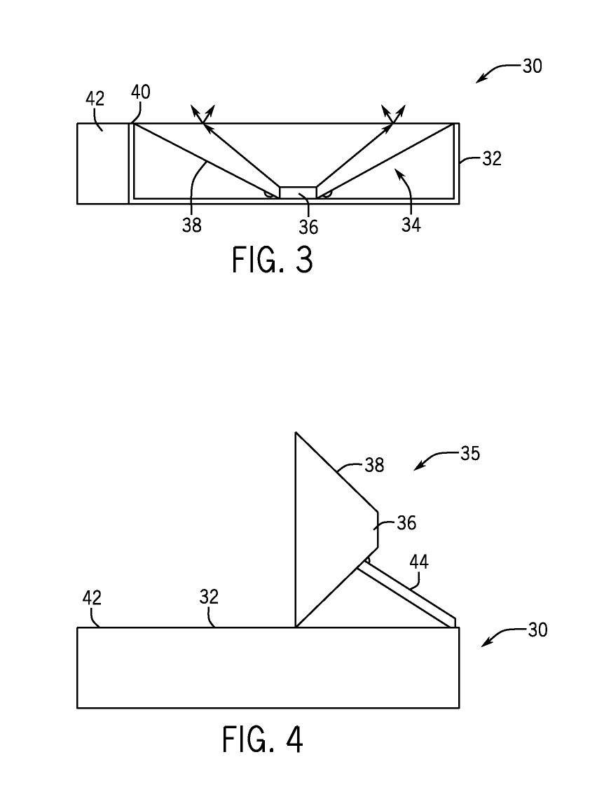

The embodiment of FIG. 3 differs from that shown in FIG. 2, in that the entire projection system and the screen are mounted within or integral with the device itself. Thus, the screen 40 simply sits on top of the body of the processor-based device 30. The projector 36 may be mounted removably on the bottom of the frame 32 of the processor-based device 30. It may include angled sidewalls 38, which may be coated to be true black and to avoid extraneous reflections.

The light projected by the projector is then viewed from outside the processor-based device 30, as is the case in the conventional display. The region 34 surrounding the emissive projector may be used to house the conventional components of a processor-based device, such as a cellular telephone, including the processor, memory, accelerometers and other devices. A portion 42 of the frame 32 may include on and off buttons and other electronics (not shown).

Then, as shown in FIG. 4, the entire projection system 35 may be removed from the body of the device by simply pulling it outwardly and rotating so that the display can be viewed, at an angle, from a position displayed from the inside of the device. In one embodiment, arms 44 may be used to support the projection system 35. It may rest on the top surface of the frame 32 of the processor-based device 30, in one embodiment. In this position, the angle or orientation of the projection display can be changed to any one desired. For example, it may be rotated completely off of the rest of the device on the arms 44 or may be removed from the arms and simply positioned on a surface connected to the rest of the device by wires.

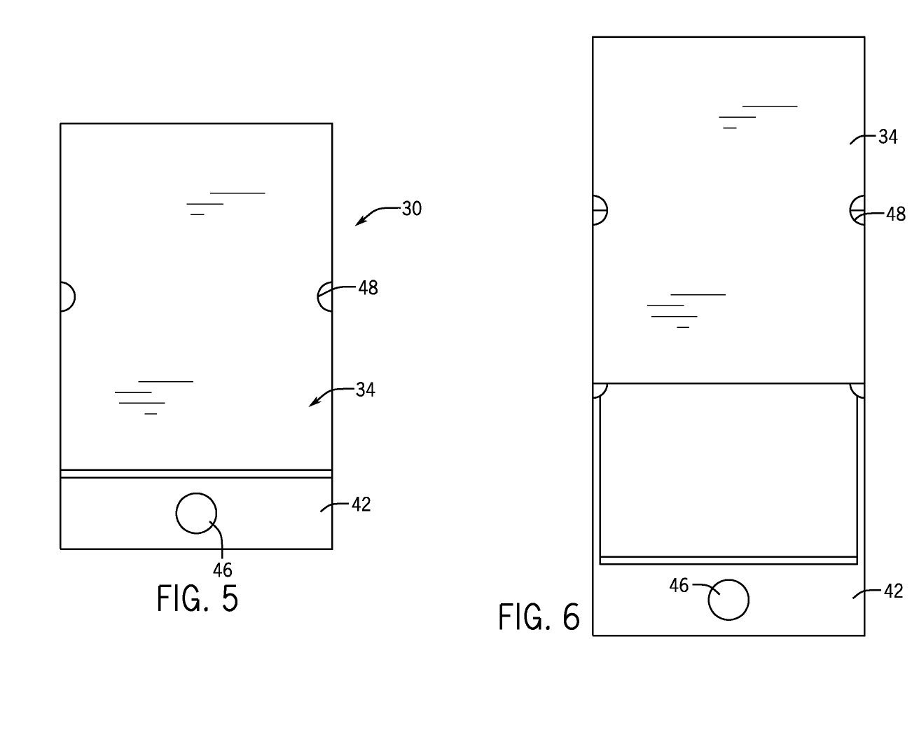

Thus, as shown in FIG. 5, the projector has its projection system 35 inside the device 30. The portion 42 may include an on/off or conventional input button 46. The screen may have a pair of slots 48 formed therein, such that it fits flush within the upper face of the processor-based device which might have a pair of lands that meet with the slots 48. It is on these lands that, in one embodiment, the projection display may sit when removed to the position outstanding of the rest of the frame, as indicated in FIG. 6.

The screen may be expandable or larger screens can be snapped in place. The image may be projected on anything that has the film applied to it (i.e., windows, counters, walls, or projection screens).

A true black background may make use of transparent display film containing the emissive particles and a black background behind it. This may be for the projector in chassis or for the projector projecting from the front (user position) to the display. Also, the basic thin display may be a black background and a layer of emissive film on top of that or the emissive particles may be directly on the surface of the opaque black background.

The following clauses and/or examples pertain to further embodiments:

One example embodiments may be an apparatus comprising a housing for a processor based device, a substantially transparent screen removably coupled to the housing for removal by pulling the screen from the housing, and an emissive projection display projector in said housing. The apparatus may include wherein said screen is mounted to pivot on said housing. The apparatus may include wherein said projector is mounted on said housing for pivotal motion. The apparatus may include wherein said projector may be pulled by a user out of said housing. The apparatus may include wherein said projector is internal to said housing. The apparatus may include wherein said projector is at least partially external of said housing. The apparatus may include a snap fit connection between said housing and said screen. The apparatus may include wherein said screen includes stacked layers having different fluorescent materials.

Another example embodiment may be an apparatus comprising a processor based device housing, a substantially transparent screen removably and replaceably coupled to the housing, and an emissive projection display projector in said housing. The apparatus may include wherein said screen is mounted to pivot on said housing. The apparatus may include wherein said projector is mounted on said housing for pivotal motion. The apparatus may include wherein said projector may be pulled by a user out of said housing. The apparatus may include wherein said projector is internal to said housing. The apparatus may include wherein said projector is at least partially external of said housing. The apparatus may include a snap fit connection between said housing and said screen. The apparatus may include wherein said screen includes stacked layers having different fluorescent materials.

Another example embodiment may be a method comprising removably and replaceably coupling an emissive projection display screen on a housing and mounting an emissive projection display projector in said housing. The method may also include mounting said screen to pivot on said housing. The method may also include mounting said projector on said housing for pivotal motion. The method may also include enabling said projector to be pulled by a user out of said housing. The method may also include providing a snap fit connection between said housing and said screen. The method may also include providing said screen with stacked layers having different fluorescent materials.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. An apparatus comprising:
a housing for a processor based device;
a substantially transparent screen removably coupled to the housing for removal by pulling the screen from the housing; and
an emissive projection display projector in said housing.

2. The apparatus of claim 1 wherein said screen is mounted to pivot on said housing.

3. The apparatus of claim 1 wherein said projector is mounted on said housing for pivotal motion.

4. The apparatus of claim 1 wherein said projector may be pulled by a user out of said housing.

5. The apparatus of claim 1 wherein said projector is internal to said housing.

6. The apparatus of claim 1 wherein said projector is at least partially external of said housing.

7. The apparatus of claim 1 including a snap fit connection between said housing and said screen.

8. The apparatus of claim 1 wherein said screen includes stacked layers having different fluorescent materials.

9. An apparatus comprising:
a processor based device housing;
a substantially transparent screen removably and replaceably coupled to the housing; and
an emissive projection display projector in said housing.

10. The apparatus of claim 9 wherein said screen is mounted to pivot on said housing.

11. The apparatus of claim 9 wherein said projector is mounted on said housing for pivotal motion.

12. The apparatus of claim 9 wherein said projector may be pulled by a user out of said housing.

13. The apparatus of claim 9 wherein said projector is internal to said housing.

14. The apparatus of claim 9 wherein said projector is at least partially external of said housing.

15. The apparatus of claim 9 including a snap fit connection between said housing and said screen.

16. The apparatus of claim 9 wherein said screen includes stacked layers having different fluorescent materials.

17. A method comprising:
removably and replaceably coupling an emissive projection display screen on a housing; and
mounting an emissive projection display projector in said housing.

18. The method of claim 17 including mounting said screen to pivot on said housing.

19. The method of claim 17 including mounting said projector on said housing for pivotal motion.

20. The method of claim 17 including enabling said projector to be pulled by a user out of said housing.

21. The method of claim 17 including providing a snap fit connection between said housing and said screen.

22. The method of claim 17 including providing said screen with stacked layers having different fluorescent materials.
